(19) United States
(12) Patent Application Publication
(10) Pub. No.: US 2023/0030863 A1
(43) Pub. Date: Feb. 2, 2023

(54) TRANSFER CONTROL APPARATUS, OPERATION METHOD OF TRANSFER CONTROL APPARATUS, AND NON-TRANSITORY COMPUTER-READABLE STORAGE MEDIUM

(71) Applicant: CANON KABUSHIKI KAISHA, Tokyo (JP)

(72) Inventor: Kenta Matsuya, Kanagawa (JP)

(21) Appl. No.: 17/852,493

(22) Filed: Jun. 29, 2022

(30) Foreign Application Priority Data
Jul. 28, 2021 (JP) 2021-123563

(51) Int. Cl. H04N 7/18; H04N 5/232; H04N 5/247

(52) U.S. Cl. CPC H04N 7/181; H04N 5/23229; H04N 5/247; H04N 5/23206

(57) ABSTRACT

A transfer control apparatus obtains statistics information related to a plurality of captured images captured by a plurality of image capturing apparatuses, obtains image capturing apparatus parameters of the plurality of image capturing apparatuses, determines an abnormality in each image capturing apparatus based on the statistics information and the image capturing apparatus parameters, and controls transfer of a plurality of captured images based on a determination.

### BACKGROUND

### Field

The present disclosure relates to a transfer control apparatus, an operation method of a transfer control apparatus, and a non-transitory computer-readable storage medium.

### Description of the Related Art

A technique referred to as virtual viewpoint video has been drawing attention, which allows for viewing a subject as video from various viewpoints and angles. For example, a virtual viewpoint video allows for viewing high light scenes of soccer or basketball games from various angles, and therefore can provide users with a higher realistic sensation than a normal video. Such a virtual viewpoint video is generated from video captured from multiple directions at a same timing, using a plurality of cameras installed as surrounding the subject. Images captured by the plurality of cameras are separated into those of the subject and those of the background other than the subject to extract silhouette images of the subject. Furthermore, a three-dimensional shape is derived from the silhouette images at different viewpoints using the volume intersection method or the like. There is also known a technique for generating a video at an arbitrary viewpoint by rendering texture information captured by a camera into a three-dimensional shape, based on information of the viewpoint specified by the operator.

In such a technique for generating a virtual viewpoint video from multi-viewpoint images captured by a plurality of cameras, existence of a camera, in which an abnormality caused by device failure, an unintended captured subject, or misalignment of the camera has occurred, may wastefully consume network bandwidth and lose a transferring opportunity of normal data. In addition, the foregoing may derive a three-dimensional shape using data of an image capturing apparatus in an abnormal state, which may lead to image quality degradation of the virtual viewpoint video.

Patent Literature 1 discloses an abnormality estimation technique based on the amount of data of cameras in a similar capturing direction.

### CITATION LIST

### Patent Literature

Patent Literature 1: Japanese Patent No. 5499752

However, the technique described in Patent Literature 1 cannot determine an abnormality in a case where there is no difference in the amount of data when the video data is compressed. Therefore, it is actually difficult to suppress an increase in load on the network bandwidth due to data transfer from an image capturing apparatus in an abnormal state, and the image quality degradation of the virtual viewpoint video due to influence of the data of the image capturing apparatus in an abnormal state.

The present disclosure, which has been made in view of the aforementioned problems, provides a technique for determining an abnormality in an image capturing apparatus with high accuracy, and suppressing data transfer from the image capturing apparatus in an abnormal state.

### SUMMARY

According to one aspect of the present disclosure, there is provided a transfer control apparatus, obtaining statistics information related to a plurality of captured images captured by a plurality of image capturing apparatuses, obtaining image capturing apparatus parameters of the plurality of image capturing apparatuses, determining an abnormality in each image capturing apparatus based on the statistics information and the image capturing apparatus parameters; and controlling transfer of a plurality of captured images based on a determination result.

Further features of the present disclosure will become apparent from the following description of exemplary embodiments (with reference to the attached drawings).

### BRIEF DESCRIPTION OF THE DRAWINGS

FIG. 1 is a schematic configuration diagram of a transfer control apparatus according to an embodiment:

FIG. 2 is a network configuration diagram of a transfer control apparatus according to an embodiment;

FIG. 3 illustrates an installation example of image capturing apparatuses according to an embodiment;

FIG. 4 illustrates an example of stored information stored in an image capturing apparatus parameter storage unit according to an embodiment;

FIG. 5 is a flowchart illustrating a procedure of an abnormal state determination unit according to an embodiment;

FIG. 6 is a flowchart illustrating a procedure of an abnormal state determination process based on installation location information according to an embodiment;

FIG. 7 is a flowchart illustrating a procedure of an abnormal state determination process based on capturing area information according to an embodiment;

FIG. 8 is a flowchart illustrating a procedure of an abnormal state determination process based on capturing direction information according to an embodiment;

FIG. 9 is a flowchart illustrating a procedure of a transfer control determination unit according to an embodiment; and

FIG. 10 illustrates an example of a hardware configuration of a transfer control apparatus according to an embodiment.

### DESCRIPTION OF THE EMBODIMENTS

Hereinafter, embodiments will be described in detail with reference to the attached drawings. Note, the following embodiments are not intended to limit the scope of the claimed disclosure. Multiple features are described in the embodiments, but limitation is not made a disclosure that requires all such features, and multiple such features may be combined as appropriate. Furthermore, in the attached drawings, the same reference numerals are given to the same or similar configurations, and redundant description thereof is omitted.

System Configuration

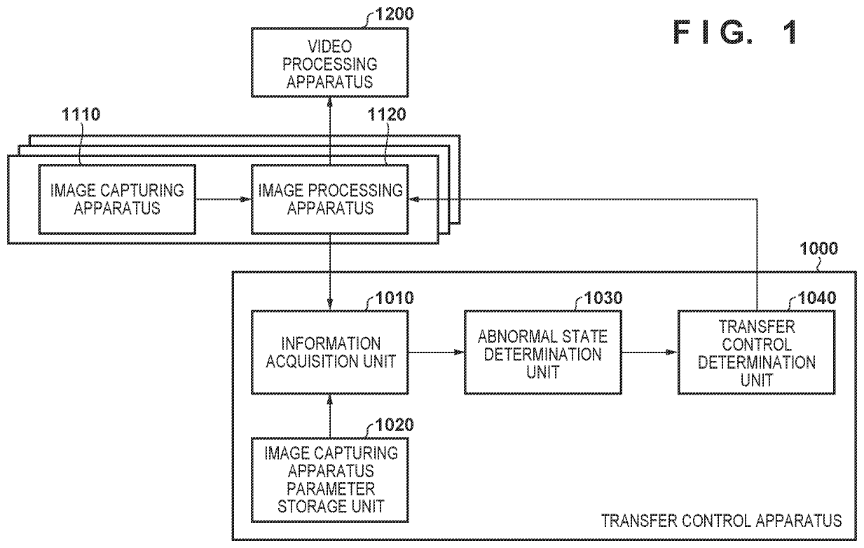

First, referring to FIG. 1, a configuration example of a virtual viewpoint video generation system according to an embodiment will be described. The virtual viewpoint video generation system includes a transfer control apparatus 1000, a plurality of image capturing apparatuses 1110, a plurality of image processing apparatuses 1120, and a video processing apparatus 1200.

The image capturing apparatus 1110 is a digital video camera or the like. For example, the image capturing apparatus 1110 is a digital video camera including a video signal interface represented by a serial digital interface (SDI). The image capturing apparatus 1110 outputs video data to the image processing apparatus 1120 via the video signal interface.

The image processing apparatus 1120 is an arithmetic operation apparatus represented by a server or a CPU that can perform arithmetic operations including image processing for a captured image input from the image capturing apparatus 1110. The image processing apparatus 1120 first performs a correction process on a captured image input from the image capturing apparatus 1110 with respect to lens-specific distortion and shake of the image capturing apparatus. Next, the image processing apparatus 1120 extracts, using a method represented by the background difference method or the like, and compresses foreground data of the subject, and forwards the data to the video processing apparatus 1200. The foreground data includes texture data and binarized silhouette data.

The video processing apparatus 1200 derives three-dimensional shape information from the foreground data input from the plurality of image processing apparatuses 1120, using the volume intersection method or the like. The volume intersection method is a technique for acquiring a three-dimensional shape information by back-projecting silhouette images from a plurality of image capturing apparatuses into a three-dimensional space, and acquiring an intersection portion of respective view volumes. A virtual viewpoint video is generated by performing a rendering process using the aforementioned three-dimensional shape information and texture data input from the image processing apparatus 1120.

<Functional Configuration of Transfer Control Apparatus>

Next, there will be described an example of the functional configuration of the transfer control apparatus 1000. The transfer control apparatus 1000 includes an information acquisition unit 1010, an image capturing apparatus parameter storage unit 1020, an abnormal state determination unit 1030, and a transfer control determination unit 1040.

The information acquisition unit 1010 acquires image capturing apparatus parameters of the plurality of image capturing apparatuses 1110 from the image capturing apparatus parameter storage unit 1020 described below. Each piece of statistics information related to the captured image is acquired from the image processing apparatus 1120, based on the information of the image capturing apparatus 1110 acquired from the image capturing apparatus parameter storage unit 1020. Although the present embodiment is described with an example of acquiring values of shake correction amount, foreground ratio, and compression ratio as the statistics information related to the captured image, only a part instead of all of which may be acquired, or information other than the foregoing may be acquired as statistics information. The shake correction amount, foreground ratio, and compression ratio will be described below. For example, the information acquisition unit 1010 acquires pieces of statistics information from respective image processing apparatuses 1120, based on the information of respective image capturing apparatuses 1110 acquired from the image capturing apparatus parameters. Note that, although the present embodiment is described with an example of acquiring statistics information via the image processing apparatus 1120, the statistics information may be acquired from the image capturing apparatus 1110 in a case where the image capturing apparatus 1110 is integrated with the image processing apparatus 1120.

The image capturing apparatus parameter storage unit 1020 has a function of storing a plurality of image capturing apparatus parameters for estimating, by the abnormal state determination unit 1030 described below, the image capturing apparatus 1110 in an abnormal state. In the present embodiment, although the image capturing apparatus parameter includes the installation location information of the image capturing apparatus 1110 and information of the capturing area and the capturing direction as the image capturing apparatus parameters, not all but a part of the aforementioned pieces of information, or other pieces of information may be stored.

The abnormal state determination unit 1030 has a function of estimating an abnormal state in the image capturing apparatus using the image capturing apparatus parameters acquired by the information acquisition unit 1010 from the image capturing apparatus parameter storage unit 1020, and the statistics information of the image capturing apparatus 1110 acquired by the information acquisition unit 1010 from the image processing apparatus 1120.

For example, the abnormal state determination unit 1030 compares statistics information of the plurality of image capturing apparatuses 1110 to estimate an abnormal state in the image capturing apparatus 1110.

The transfer control determination unit 1040 has a function of determining and controlling the transfer function of the image processing apparatus 1120 based on the result of abnormal state estimation by the abnormal state determination unit 1030. Here, the transfer function may be determined using only the information representing whether an abnormal state or not, or may be determined using a combination of a plurality of pieces of information such as the image capturing apparatus parameters. In the present embodiment, the transfer function is determined from information of an abnormal state in the image capturing apparatus 1110.

<Hardware Configuration of Transfer Control Apparatus>

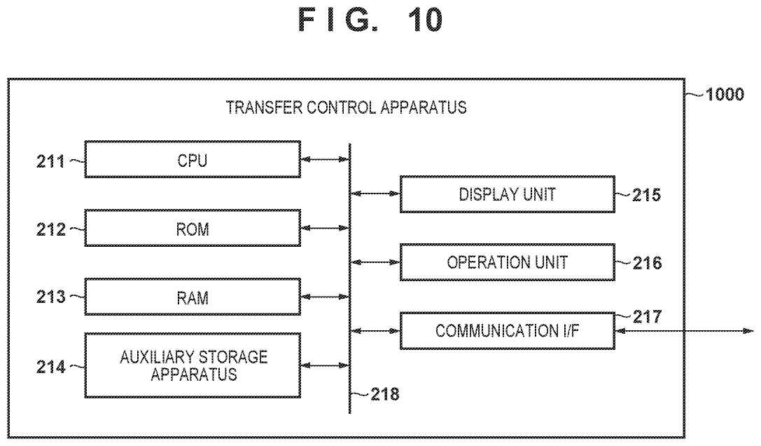

Subsequently, a hardware configuration of the transfer control apparatus 1000 according to an embodiment will be described, referring to FIG. 10. Note that hardware configurations of the image capturing apparatus 1110, the image processing apparatus 1120, and the video processing apparatus 1200 may be configured similarly to the configuration of the transfer control apparatus 1000 described below. The transfer control apparatus 1000 includes a Central Processing Unit (CPU) 211, a Read Only Memory (ROM) 212, a Random Access Memory (RAM) 213, an auxiliary storage apparatus 214, a display unit 215, an operation unit 216, a communication I/F 217, and a bus 218.

The CPU 211 realizes the functions of the transfer control apparatus 1000 illustrated in FIG. 1 by controlling the transfer control apparatus 1000 as a whole using computer programs and data stored in the ROM 212 or the RAM 213. Here, the transfer control apparatus 1000 may include a plurality of dedicated hardware different from the CPU 211, and the dedicated hardware may execute at least a part of the processes which would otherwise be performed by the CPU 211. Examples of the dedicated hardware include an application specific integrated circuit (ASIC), a field programmable gate array (FPGA), and a digital signal processor (DSP). The ROM 212 stores programs or the like that need not be changed. The RAM 213 temporarily stores programs and data supplied from the auxiliary storage apparatus 214, or data supplied from the outside via the communication I/F 217. The auxiliary storage apparatus 214, including for example a hard disk drive or the like, stores a variety of data such as image data and audio data.

The display unit 215, including for example a liquid crystal display, an LED or the like, displays a Graphical User Interface (GUI) or the like that allows the user to operate the transfer control apparatus 1000. The operation unit 216, including for example a keyboard, a mouse, a joy stick, a touch panel or the like, inputs various instructions to the CPU 211 upon receiving a user's operation. The communication I/F 217 is used for communication with apparatuses external to the transfer control apparatus 1000. For example, when wire-connecting the transfer control apparatus 1000 to an external apparatus, a communication cable is connected to the communication I/F 217. In a case where the transfer control apparatus 1000 has a function of wirelessly communicating with an external apparatus, the communication I/F 217 is provided with an antenna. The bus 218 transmits information by providing connection between the units of the transfer control apparatus 1000.

Although it is assumed in the present embodiment that the display unit 215 and the operation unit 216 exists inside the transfer control apparatus 1000, at least either the display unit 215 or the operation unit 216 may exist outside the transfer control apparatus 1000 as a separate apparatus. In this case, the CPU 211 may operate as a display control unit that controls the display unit 215, and an operation control unit that controls the operation unit 216.

<Network Configuration>

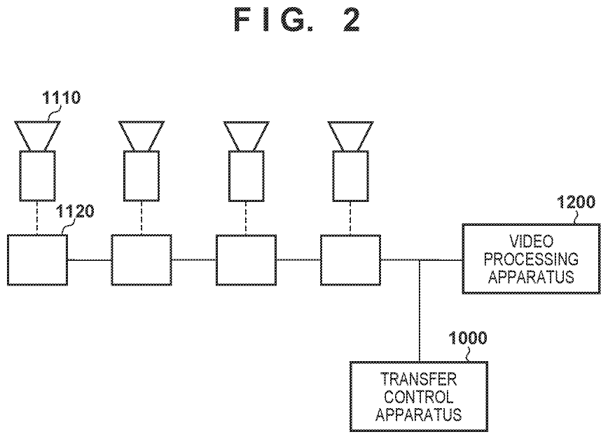

Next, a network configuration will be described. FIG. 2 illustrates an example of a network configuration of the virtual viewpoint video generation system according to an embodiment. The image processing apparatuses 1120, which are daisy-chain connected, process a captured image input from the image capturing apparatus 1110, and transfer the processed image to the video processing apparatus 1200 connected within a same network. Therefore, when an image processing apparatus in an abnormal state exists among the image processing apparatuses 1120, data that should not be used for virtual viewpoint video generation may flow, thereby applying a load on the band of the network.

The transfer control apparatus 1000, which is connected to the same network as that of the image processing apparatuses 1120 and the video processing apparatus 1200, reduces the load on the band of the network by estimating an abnormal state in the image processing apparatuses 1120, and controlling the transfer function. Although the present embodiment is described with an example in which the image processing apparatuses 1120 are wire-connected in a daisy-chain manner, the disclosure is not limited thereto, other types of network topology may be used, such as star connection, mesh connection, wireless LAN, public wireless LAN, or the like.

<Installation Example of Image Capturing Apparatus>

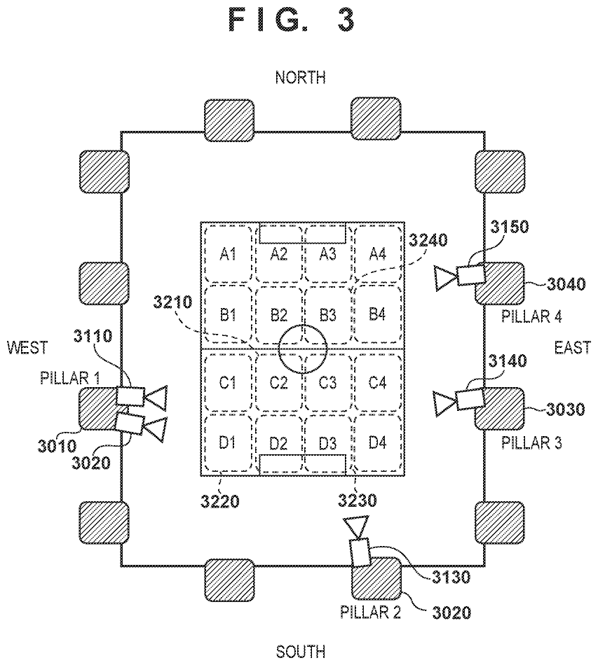

FIG. 3 illustrates an installation example of a plurality of image capturing apparatuses according to an embodiment. The configuration of each image capturing apparatus is similar to that of the image capturing apparatus 1110 in FIG. 1. In the example of FIG. 3, a plurality of image capturing apparatuses 3110 to 3150 are installed on pillars 3010 to 3040 in a manner surrounding a stadium that is a capturing target, and capturing specific areas 3210 to 3240 defined by dividing the capturing region. Although a pillar is mentioned as the installation location of the image capturing apparatus in the present embodiment, the installation location is not limited to pillars and anything may be used for installing the image capturing apparatuses as long as it allows for distinguishing whether or not the installation locations or positions are identical.

<Description of Image Capturing Apparatus Parameters>

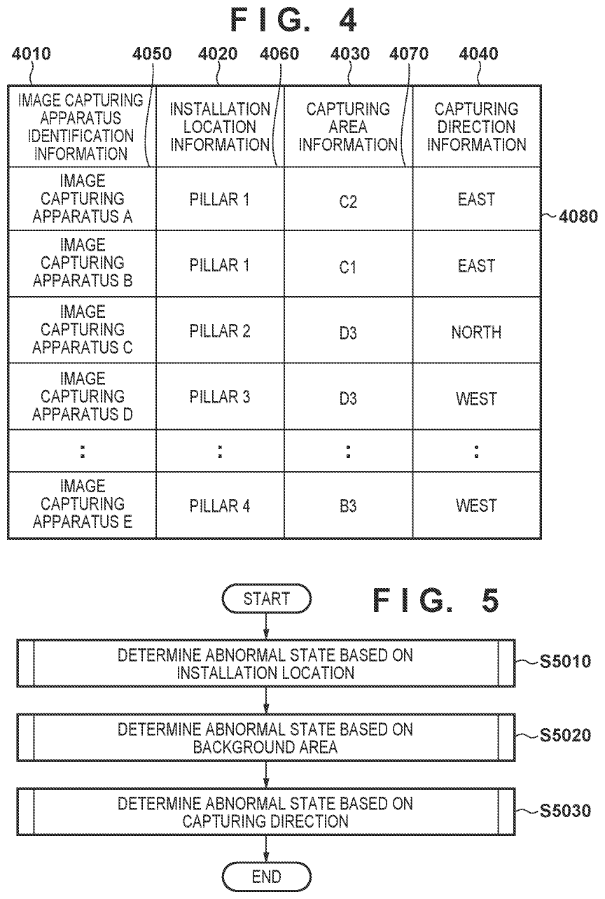

Next, there will be an example of image capturing apparatus parameters stored in the image capturing apparatus parameter storage unit 1020 according to an embodiment, referring to FIG. 4.

In the present embodiment, the image capturing apparatus parameter storage unit 1020 stores installation location information 4020, capturing area information 4030, and capturing direction information 4040. Here, the information stored in the image capturing apparatus parameter storage unit 1020 is not limited to the aforementioned pieces of information.

Additionally, in the present embodiment, the installation location information 4020 indicates the installed pillar numbers, the capturing area information 4030 indicates the capturing area numbers when a game field that is the capturing target is divided into 16 areas, and the capturing direction information 4040 indicates the closest direction among the cardinal directions north, south, east and west. Here, the granularity of the information to be stored is not limited to thereto and, for example, the game field may be divided into 16 or more areas, or the direction may be indicated by more than the four cardinal directions.

<Statistics Information Related to Captured Images>

The information acquisition unit 1010 acquires, from the image processing apparatus 1120, statistics information related to the captured image, based on the image capturing apparatus identification information 4010 stored in the image capturing apparatus parameter storage unit 1020 and the image capturing apparatus parameters (installation location information 4020, capturing area information 4030, and/or capturing direction information 4040). In the present embodiment, at least one of the shake correction amount, the foreground ratio, and the compression ratio are acquired from the image processing apparatus 1120 as statistics information.

The shake correction amount refers to a correction amount for an angle-of-view shift in a captured image due to shake or misalignment of the image capturing apparatus 1110, and is calculated by comparing the captured image input from the image capturing apparatus 1110 with a preliminarily acquired reference image. For the correction amount, a correction amount such as 6 pixels in the positive direction of the x-component and 10 pixels in in the negative direction of the y-component, for example, may be used, or a correction amount such as √6²+10²≈12 derived by using the Pythagorean theorem may be used, regardless of the form of the correction amount.

The foreground ratio, which refers to a proportion occupied by a subject (hereinafter referred to as foreground) of the captured image input from the image capturing apparatus 1110, can be expressed as (total number of pixels in the foreground)/(total number of pixels)×100). For example, in a case where a foreground 1 (600×700 pixels in vertical and horizontal directions) and a foreground 2 (400×300 pixels in vertical and horizontal directions) are extracted in a 4K image (4096×2160 pixels in vertical and horizontal directions), the foreground ratio is 6.1% as calculated by ((420000+120000)/8847360)×100≈6.1.

The compression ratio, which refers to the coding efficiency in an image coding process of the foreground data, can be expresses as ((post-compression data size)/(pre-compression data size)×100). There are various schemes for image coding process such as a reversible compression or irreversible compression, and any of the coding schemes may be used.

In addition, the statistics information acquired from the image processing apparatus 1120 is not limited to the aforementioned pieces of information, and other pieces of information may be used.

<Abnormal State Determination Process>

The abnormal state determination unit 1030 of the transfer control apparatus 1000 estimates an abnormal state in the image capturing apparatus using the image capturing apparatus parameters acquired from the image capturing apparatus parameter storage unit 1020 by the information acquisition unit 1010, and the statistics information acquired from the image capturing apparatus 1110 by the information acquisition unit 1010.

In the present embodiment, the abnormal state determination process is performed, based on the installation location information 4020, the capturing area information 4030, and/or the capturing direction information 4040.

The abnormal state determination process based on the installation location information estimates the image capturing apparatus 1110 in an abnormal state by comparing the shake correction amounts of the image capturing apparatuses 1110, from the perspective that the trend of shakes of the image capturing apparatuses 1110 installed on a same pillar are similar.

The abnormal state determination process based on the capturing area estimates the image capturing apparatus 1110 in an abnormal state by comparing the foreground ratio of the image capturing apparatus 1110, from the perspective that the trend of numbers and sizes of subjects of the image capturing apparatuses 1110 capturing a same area are similar.

The abnormal state determination process based on the capturing direction estimates the image capturing apparatus 1110 in an abnormal state by comparing the compression ratios of the image capturing apparatuses 1110 influenced by the dark noise due to brightness or shadow, from the perspective that the state of brightness or shadow of the image capturing apparatuses 1110 capturing in a same direction are similar.

Here, the information used for estimating an abnormal state may be combined with the aforementioned plurality of pieces of information. Furthermore, other pieces of information may be used without being limited to the aforementioned pieces of information.

Subsequently, there will be described a procedure of processing performed by the abnormal state determination unit 1030 of the transfer control apparatus 1000 according to the present embodiment, referring to the flowchart of FIG. 5.

At step S5010, the abnormal state determination unit 1030 performs abnormal state determination process based on the installation location information 4020, and moves to step S5020. At step S5020, the abnormal state determination unit 1030 performs abnormal state determination process based on the capturing area information 4030, and moves to step S5030. At step S5030, the abnormal state determination unit 1030 performs abnormal state determination process based on the capturing direction information 4040, and terminates the series of processing.

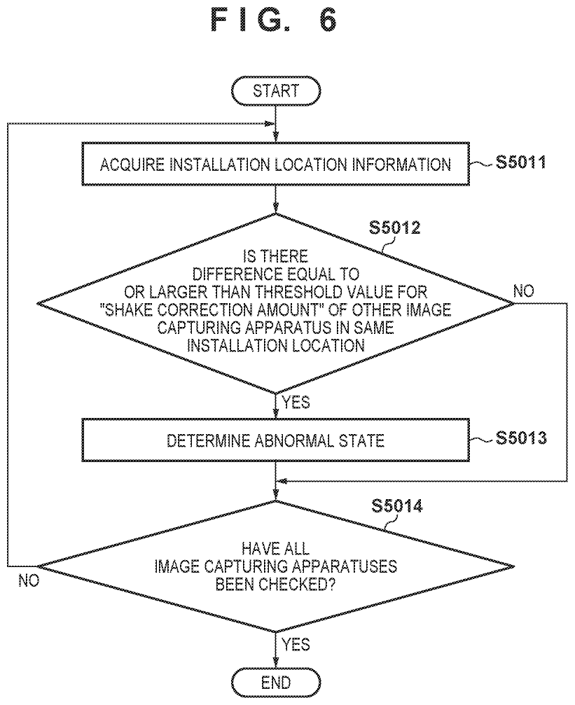

Next, a processing procedure of the processing at S5010 of FIG. 5 will be described in detail, referring to the flowchart of FIG. 6. At step S5011, the abnormal state determination unit 1030 acquires the installation location information 4060 of the image capturing apparatus 4050.

At step S5012, the abnormal state determination unit 1030 compares the shake correction amounts of all the image capturing apparatuses having same installation location information as the installation location information 4060 acquired at step S011, and determines whether or not there is a difference equal to or larger than a preliminarily registered threshold value. In other words, abnormality in each image capturing apparatus is determined by comparing the shake correction amounts of a plurality of image capturing apparatuses having installation location information in common. For example, the result of the step S5012 is Yes when the shake correction amount of the image capturing apparatus 4050 is 17 pic, where the mean of the shake correction amounts of other image capturing apparatuses in the installation location information 4060 is 10 pic and the abnormality determination threshold value is 5 pic. Here, determination of the current step may be performed simply based on the distance from the mean or the median as in the present embodiment, or may use an approach such as outlier detection.

At step S5013, the abnormal state determination unit 1030 determines that the image capturing apparatus 4050 is in an abnormal state. The abnormal state determination unit 1030 then provides the image capturing apparatus 4050, estimated to be abnormal, with flag information that allows for discriminating that the image capturing apparatus 4050 is estimated to be abnormal, and moves to step S5014.

At step S5014, the abnormal state determination unit 1030 determines whether or not the abnormal state determination process based on the shake correction amount has been completed for all the image capturing apparatuses indicated in the image capturing apparatus identification information 4010 included in the image capturing apparatus parameters acquired by the information acquisition unit 1010. In a case where the abnormal state determination process has not been completed for all the image capturing apparatuses, the processing returns to step S5011 and repeats the process. On the other hand, the series of processing is terminated upon completion of the abnormal state determination process for all the image capturing apparatuses.

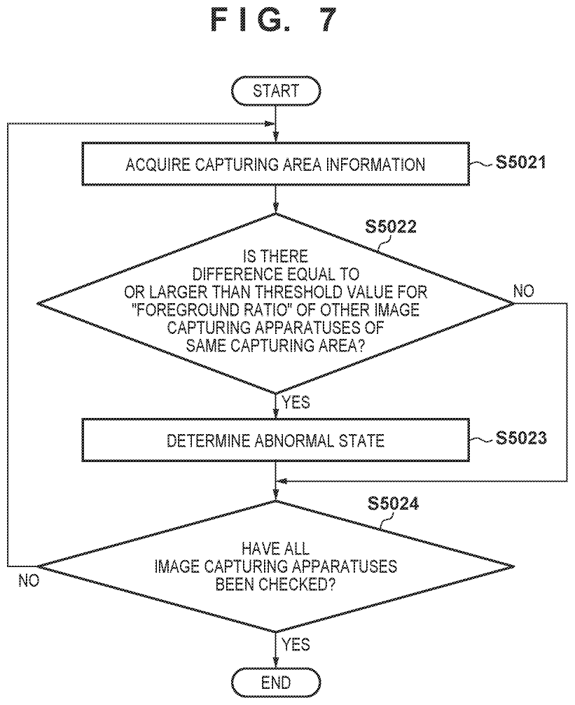

Furthermore, a processing procedure of the processing at S5020 of FIG. 5 will be described in detail, referring to the flowchart of FIG. 7. At step S5021, the abnormal state determination unit 1030 acquires the capturing area information 4070 of the image capturing apparatus 4050.

At step S5022, the abnormal state determination unit 1030 compares the foreground ratios of all the image capturing apparatuses having same capturing area information as the capturing area information 4070 acquired at step S021, and determines whether or not there is a difference equal to or larger than a preliminarily registered threshold value. For example, when the foreground ratio of the image capturing apparatus indicated in the capturing area information 4070 is 6%, the mean of the foreground ratios provided by other image capturing apparatuses capturing the same area is 10%, and the threshold value is 3%, the difference 10%−6%=4% is larger than the threshold value of 3%, whereby the result of the step S5022 is Yes. Here, determination of the current step may simply use the mean as in the present embodiment, or may be performed based on the distance from the median, or may use an approach such as outlier detection.

Since the processing at S5023 and S5024 are similar to those at S5013 and S5014, description thereof is omitted.

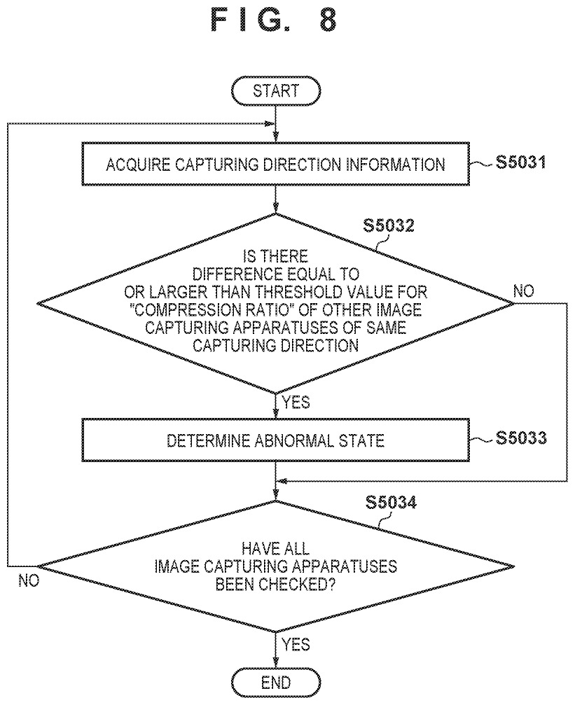

Furthermore, a processing procedure of the processing at S5030 of FIG. 5 will be described in detail, referring to the flowchart of FIG. 8. At step S5031, the abnormal state determination unit 1030 acquires the capturing direction information 4080 of the image capturing apparatus 4050.

At step S5032, the abnormal state determination unit 1030 compares the compression ratios of all the image capturing apparatuses having the same capturing direction information as the capturing direction information 4080 acquired at step S011, and determines whether or not there is a difference equal to or larger than a predetermined threshold value. For example, when the capturing direction of the image capturing apparatuses of the capturing direction information 4080 is east, the mean of the compression ratios provided by other image capturing apparatuses capturing in the same capturing direction is 20%, and the compression ratio of the image capturing apparatus indicated in the capturing direction information 4080 is 15%, and the threshold value is 3%, the difference 20%−15%=5% is larger than the threshold value of 3%, whereby the result of the step S5032 is Yes. Here, determination of the current step may simply use the mean as in the present embodiment, or may be performed based on the distance from the median, or may use an approach such as outlier detection.

Since the processing at S5033 and S5034 are similar to those at S5013 and S5014, description thereof is omitted.

Although all of the steps S5010 to S5030 are executed in FIG. 5 to perform the determination in the present embodiment, it is not necessary to execute all of the steps, and may be configured to execute only one or two of the steps.

<Determination Process of Transfer Control Function>

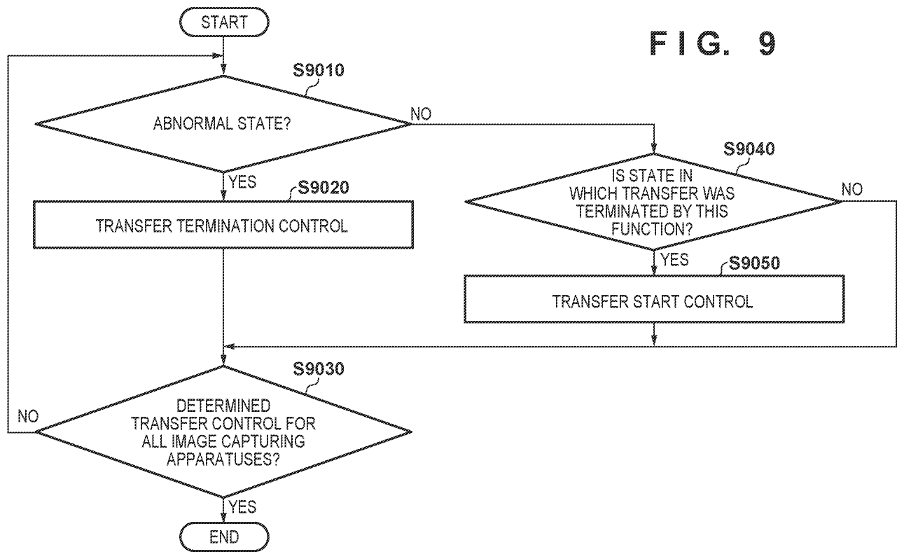

Subsequently, there will be described a procedure of processing performed by the transfer control determination unit 1040 of the transfer control apparatus 1000 according to the present embodiment, referring to the flowchart of FIG. 9.

At step S9010, the transfer control determination unit 1040 refers to the abnormal state estimated by the abnormal state determination unit 1030. When it is estimated to be an abnormal state, the processing moves to step S9020. When it is not estimated to be an abnormal state, the processing moves to step S9040.

At step S9020, the transfer control determination unit 1040 performs control to terminate the transfer function of the image processing apparatus 1120 corresponding to the image capturing apparatus 1110 estimated to be in an abnormal state by the abnormal state determination unit 1030. Alternatively, a control may be performed to lower the transfer priority of captured images of the image capturing apparatus estimated to be in an abnormal state by the abnormal state determination unit 1030. Here, determination of terminating the transfer function may be performed based on not only the determination result of the abnormal state, but also on a combination with other pieces of information such as importance or capturing area of the image capturing apparatus 1110.

At step S9030, the transfer control determination unit 1040 determines whether or not control contents for the transfer function based on the abnormal state estimation result provided by the abnormal state determination unit 1030 has been determined for all the image processing apparatuses 1120 corresponding to all the image capturing apparatuses 1110. In a case where the control contents for the transfer function has not been determined for all the image processing apparatuses 1120, the processing returns to step S9010 and repeats the series of processing. On the other hand, in a case where the control contents for the transfer function has been determined for all the image processing apparatuses 1120, the process is terminated.

At step S9040, the transfer control determination unit 1040 determines whether or not the transfer function is terminated in accordance with the previous estimation for the image processing apparatus 1120 corresponding to the image capturing apparatus 1110 estimated not to be in an abnormal state. In a case where the transfer function has been terminated, it is considered that the abnormal state has been resolved, and the processing moves to step S9050. On the other hand, in a case where the transfer function is not terminated, the processing moves to step S9030.

At step S9050, the transfer control determination unit 1040 performs a control of starting the transfer function for the image capturing apparatus 1110 estimated not to be in an abnormal state. Here, determination of starting the transfer function may be performed using not only the estimation result of the abnormal state resolution, but also the elapsed time after transition from the abnormal state to the normal state or the recurrence frequency of the abnormal state within a certain time.

As such, abnormality estimation is performed based on statistics information of a plurality of image capturing apparatuses having similar conditions, whereby it becomes possible to detect without overlooking an abnormality even when an abnormality cannot be detected by the image capturing apparatus alone. As a result, it is possible to suppress data transfer from an image capturing apparatus in an abnormal state, and avoid loss of a transferring opportunity of normal data due to shortage of network bandwidth. Furthermore, it is possible to prevent mixing of data from the image capturing apparatus in an abnormal state into three-dimensional shape information, whereby it is also possible to suppress the image quality degradation of the virtual viewpoint video.

As has been described above, the present embodiment allows for determining an abnormality in an image capturing apparatus with high accuracy. Accordingly, it is possible to suppress an increase in the load on the network bandwidth due to data transfer from an image capturing apparatus in an abnormal state, and suppress the image quality degradation of the virtual viewpoint video due to the influence of data from an image capturing apparatus in an abnormal state.

According to the present disclosure, it is possible to determine an abnormality in an image capturing apparatus with high accuracy and suppress data transfer from the image capturing apparatus in the abnormal state.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2021-123563, filed Jul. 28, 2021, which is hereby incorporated by reference herein in its entirety.

What is claimed is:

1. A transfer control apparatus, comprising:
one or more memories storing instructions: and
one or more processors executing the instructions to:
obtain statistics information related to a plurality of captured images captured by a plurality of image capturing apparatuses,
obtain image capturing apparatus parameters of the plurality of image capturing apparatuses,
determine an abnormality in each image capturing apparatus, based on the statistics information and the image capturing apparatus parameters; and
control transfer of a plurality of captured images based on a determination.

2. The transfer control apparatus according to claim 1, wherein
the one or more processors further execute the instructions to terminate transfer of captured images of an image capturing apparatus determined to be abnormal.

3. The transfer control apparatus according to claim 1, wherein
the one or more processors further execute the instructions to transmit, with lowered transfer priority, captured images of an image capturing apparatus determined to be abnormal.

4. The transfer control apparatus according to claim 1, wherein
the image capturing apparatus parameters include installation location information of image capturing apparatuses,
the statistics information includes a shake correction amount indicating an amount of correcting an angle-of-view shift in a captured image due to shake or misalignment of image capturing apparatuses, and
the one or more processors further execute the instructions to determine an abnormality in each image capturing apparatus by comparing shake correction amounts of a plurality of image capturing apparatuses having the installation location information in common.

5. The transfer control apparatus according to claim 4, wherein
the one or more processors further execute the instructions to determine that an image capturing apparatus, corresponding to a shake correction amount whose difference from a mean of the shake correction amounts of the plurality of image capturing apparatuses having the installation location information in common is equal to or larger than a threshold value, is abnormal.

6. The transfer control apparatus according to claim 1, wherein
the image capturing apparatus parameters include capturing area information of an image capturing apparatus,
the statistics information includes a foreground ratio that is a proportion occupied by a subject in a captured image, and
the one or more processors further execute the instructions to determine an abnormality in each capturing apparatus by comparing foreground ratios of a plurality of image capturing apparatuses having the capturing area information in common.

7. The transfer control apparatus according to claim 6, wherein
the one or more processors further execute the instructions to determine that an image capturing apparatus, corresponding to a foreground ratio whose difference from a mean of the foreground ratios of the plurality of image capturing apparatuses having the capturing area information in common is equal to or larger than a threshold value, is abnormal.

8. The transfer control apparatus according to claim 1, wherein
the image capturing apparatus parameters include capturing direction information of an image capturing apparatus,
the statistics information includes a compression ratio indicating a coding efficiency in an image coding process of a foreground data that is a subject, and
the one or more processors further execute the instructions to determine an abnormality in each capturing apparatus by comparing compression ratios of a plurality of image capturing apparatuses having the capturing direction information in common.

9. The transfer control apparatus according to claim 8, wherein
the one or more processors further execute the instructions to determine that an image capturing apparatus corresponding to a compression ratio whose difference from a mean of the compression ratios of the plurality of image capturing apparatuses having the capturing direction information in common is equal to or larger than a threshold value, is abnormal.

10. An operation method of a transfer control apparatus, the method comprising:
obtaining statistics information related to a plurality of captured images captured by a plurality of image capturing apparatuses;
obtaining image capturing apparatus parameters of the plurality of image capturing apparatuses,
determining an abnormality in each capturing apparatus, based on the statistics information and image capturing apparatus parameters of the plurality of image capturing apparatuses; and
controlling transfer of a plurality of captured images, based on a determination.

11. A non-transitory computer-readable storage medium storing a program for causing a computer to execute each process of an operation method of a transfer control apparatus, the method comprising:
obtaining statistics information related to a plurality of captured images captured by a plurality of image capturing apparatuses;
obtaining image capturing apparatus parameters of the plurality of image capturing apparatuses,
determining an abnormality in each capturing apparatus, based on the statistics information and image capturing apparatus parameters of the plurality of image capturing apparatuses; and
controlling transfer of a plurality of captured images, based on a determination.
